(19) United States
(12) Patent Application Publication
(10) Pub. No.: US 2011/0028100 A1
(43) Pub. Date: Feb. 3, 2011

(54) LOCATION AND TIME SENSING COGNITIVE RADIO COMMUNICATION SYSTEMS

(76) Inventors: Gokhan Memik, Evanston, IL (US); Seda Ogrenci Memik, Evanston, IL (US); Bill Mangione-Smith, Kirkland, WA (US)

Correspondence Address: EVAN LAW GROUP LLC, 600 WEST JACKSON BLVD., SUITE 625, CHICAGO, IL, 60661, US

(21) Appl. No.: 12/511,947

(22) Filed: Jul. 29, 2009

(51) Int. Cl. H04B 17/00

(52) U.S. Cl. 455/67.11; 455/39

(57) ABSTRACT

Techniques for determining whether or not a cognitive device may perform a cognitive task are disclosed. A cognitive device may be arranged in communication with a communications device. The cognitive device may include a cognitive receiver, an antenna, and a time and/or location determining device. The communications device may include a cognitive radio, a portable power source, and an antenna. Example cognitive devices may be configured to use time and/or location information, to determine whether or not to perform a cognitive task or determine whether to perform a cognitive task a certain way. The cognitive device may be arranged to communicate cognitive information to the communications device based on whether the cognitive task was performed.

### REFERENCE TO RELATED APPLICATIONS

This application is related to the following co-pending applications, application Ser. No. ______ (Attorney Docket No. VCS01-005-US) entitled “Spectrum Sensing Network For Cognitive Radios” filed ______; application Ser. No. ______ (Attorney Docket No. KLV01-006-US) entitled “Reputation Values in A Spectrum Sensing Network” filed ______; application Ser. No. ______ entitled “Secure Cognitive Radio Transmissions” (Attorney Docket No. BCV01-007-US) filed ______; application Ser. No. ______ (Attorney Docket No. UHV01-008-US) entitled “Cognitive Radios For Secure Transmissions” filed ______; and application Ser. No. ______ (Attorney Docket No. FDV01-009-US) entitled “Spectrum Sensing Network For Cognitive Radios” filed ______.

### BACKGROUND

The electromagnetic radio spectrum is a natural resource, the use of which by transmitters and receivers is licensed by governments. In many bands, spectrum access is a more significant problem than physical scarcity of spectrum, in large part due to legacy command-and-control regulation that limits the ability of potential spectrum users to obtain such access. Indeed, if portions of the radio spectrum were scanned, including in the revenue-rich urban areas, one would find that some frequency bands in the spectrum are largely unoccupied most of the time; some other frequency bands are only partially occupied; and the remaining frequency bands are heavily used.

The underutilization of the electromagnetic spectrum has lead to the view that spectrum holes within the electromagnetic spectrum may exist. As used herein, a spectrum hole exists when a band of frequencies assigned to a primary user is not being utilized by that user, at a particular time and specific geographic location. By making it possible for a secondary user to access the band of frequencies within a spectrum hole, utilization of the electromagnetic spectrum may be improved. A cognitive radio, inclusive of software-defined radio, has been proposed as a means to promote the efficient use of the electromagnetic spectrum by exploiting the existence of spectrum holes.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 depicts a cognitive radio;

FIG. 2 depicts a schematic representation of a communications system;

FIG. 3 depicts a flowchart illustration of methods, apparatus (systems) and computer program products;

FIG. 4 depicts a flowchart illustration of methods, apparatus (systems) and computer program products; and

FIG. 5 depicts a flowchart illustration of methods, apparatus (systems) and computer program products, all arranged in accordance with at least some embodiments of the present disclosure.

### DETAILED DESCRIPTION

The following description sets forth various examples along with specific details to provide a thorough understanding of claimed subject matter. However, it will be understood by those skilled in the art that claimed subject matter may be practiced without some or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, systems and computer program products related to determining whether or not to perform a cognitive task, for example using time and/or location information.

As used herein, the phrase “cognitive task” may include one or more (1) radio-scene analysis, (2) estimating interference temperature (a metric which quantifies sources of interference in a radio environment), (3) detecting spectrum holes, by spectrum sensing, (4) channel identification, (5) estimation of channel-state information, (6) prediction of channel capacity for use by the transmitter, (7) transmit-power control, and/or (8) dynamic spectrum management. As used herein, the phrase “cognitive device” may include a device which may be configured to carry out cognitive tasks, such as a cognitive radio, or a cognitive receiver. As used herein, the phrase “cognitive information” may include information that may be used to assist in carrying out a cognitive task. As used herein, the phrase “cognitive instruction” may include an instruction that may assist in accomplishing a cognitive task.

Some example embodiments discussed below may make use of the concept that by offloading some of the cognitive tasks performed by a cognitive radio within a portable communications device to a cognitive radio within a cognitive device, which may be coupled to a constant power source, the amount of power utilized to operate the portable communications device may be reduced and/or minimized. Additionally, by including at least one of a time determining device and a location determining device, the cognitive device may determine whether or not to perform a cognitive task, or whether to perform a cognitive task in a certain way, thereby increasing the efficiency of the cognitive device when executing cognitive tasks.

In some examples, a described communications system may include a cognitive device and a communications device. The cognitive device may include a cognitive receiver for processing a cognitive task, an antenna for receiving radio frequencies in communication with the cognitive receiver, and/or a time determining device. The communications device may include one or more of a processor in communication with a receiver and a transmitter, a portable power source in communication with the communications device, and an antenna for sending and receiving signals.

In some examples, the time determining device of the cognitive device obtains time information including the current time. Based at least in part on the obtained time information, the cognitive device may determine whether or not to perform a cognitive task or whether to perform a cognitive task a certain way. The cognitive device may communicate cognitive information upon performing the cognitive task to the communications device.

In some other examples, methods for processing a cognitive task in a cognitive device are described. The described methods may include obtaining time information (e.g., the current time) and based at least in part on the obtained time information, determine whether or not to perform a cognitive task and/or determine whether to perform a cognitive task a certain way. In some additional examples, methods for processing a cognitive task in a cognitive device are described, wherein the methods may include obtaining location information (e.g., the current location) and based at least in part on the obtained location information, determine whether or not to perform a cognitive task and/or determine whether to perform a cognitive task a certain way.

In still other examples, methods are described for processing a cognitive task in a cognitive radio, where the cognitive radio may include a processor and one or more of a receiver and a transceiver. The methods may include obtaining one or more of location information and time information, and based at least in part on the obtained information, determine whether or not to perform a cognitive task and/or determine whether to perform a cognitive task a certain way.

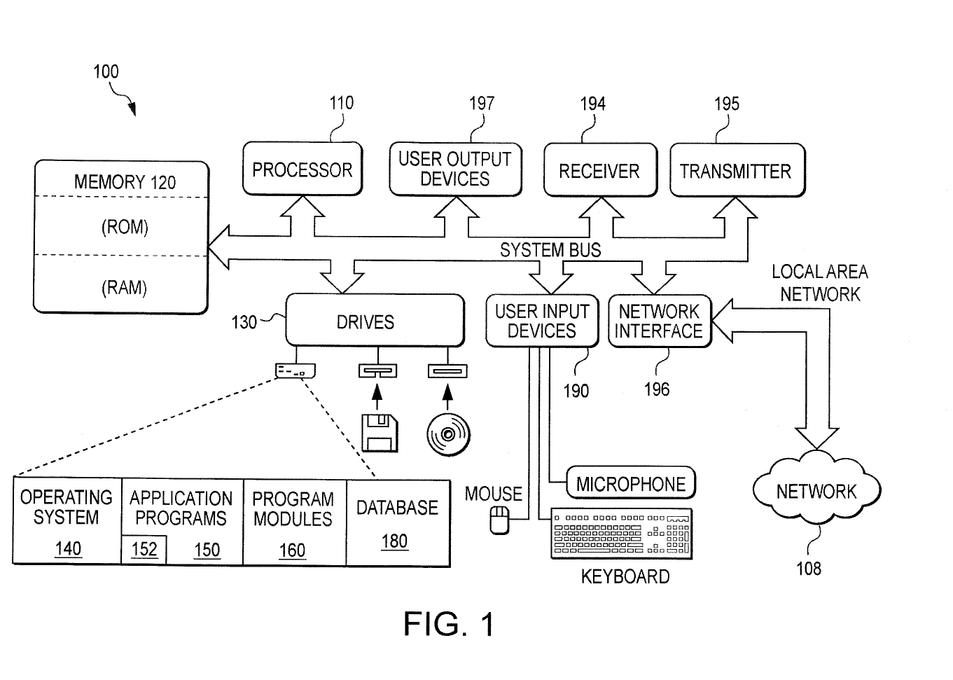

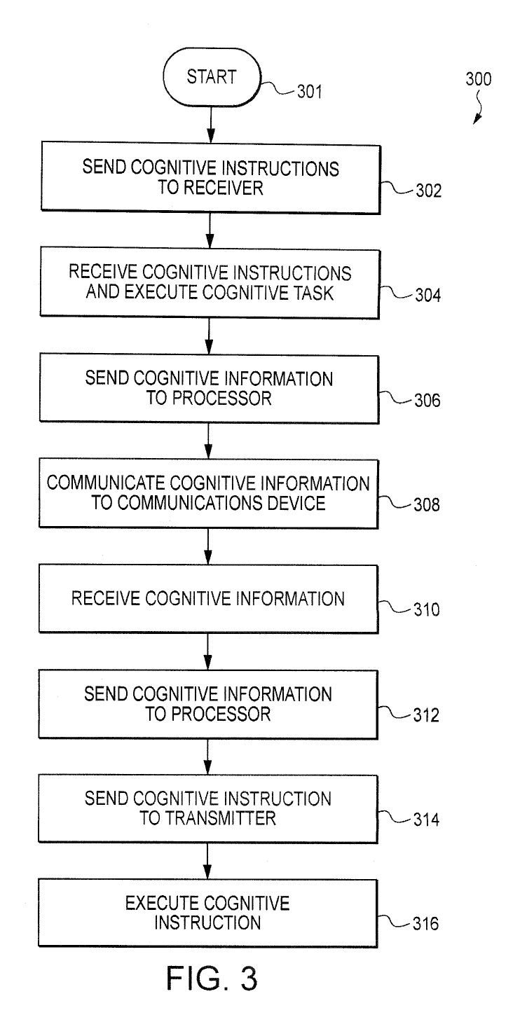

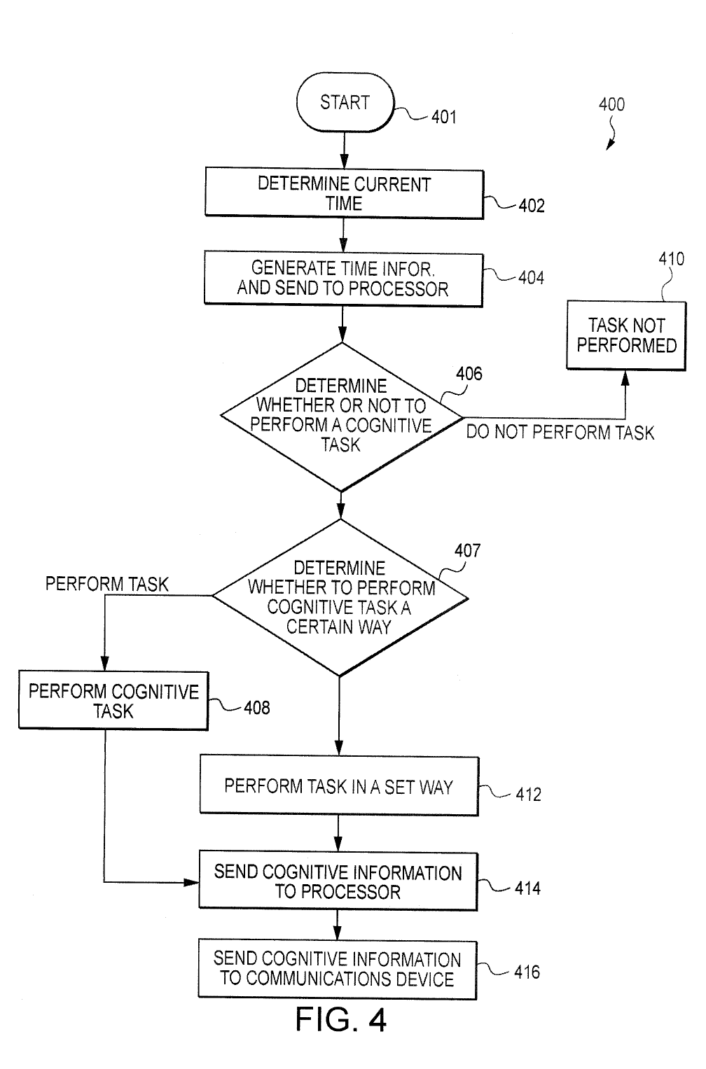

FIG. 1 depicts a cognitive radio arranged in accordance with at least some embodiments of the present disclosure. As shown in FIG. 1, a cognitive radio 100 may include a processor 1 10, a memory 120 and one or more drives 130. The drives 130 and their associated computer storage media may be arranged to provide storage of computer readable instructions, data structures, program modules and other data for the cognitive radio 100. Drives 130 can include stored there on one or more of an operating system 140, application programs 150, program modules 160, and/or a database 180. Application programs 150 may include an application program containing program instructions for causing a cognitive radio 100 to carry out the functions and/or processes specified in FIGS. 3, 4 and/or 5; for example, a method for processing a cognitive task 152. Cognitive radio 100 may further includes user input devices 190 through which a user may enter commands and/or data. Input devices can include one or more of an electronic digitizer, a microphone, a keyboard and/or a pointing device, commonly referred to as a mouse, trackball or touch pad. Other example input devices may include a joystick, game pad, satellite dish, scanner, or the like.

These and other input devices can be connected to processor 110 through a user input interface that is coupled to a system bus, but may be connected by other interface and bus structures, such as a parallel port, game port or a universal serial bus (USB). Cognitive radio 100 may also includes a receiver 194 through which radio frequency signals may be received and a transmitter 195 through which radio frequency signals may be transmitted. Cognitive radio 100 with receiver 194 and without transmitter 195 may be referred to herein as a cognitive receiver, and cognitive radio 100 with transmitter 195 and without receiver 194 may be referred to herein as a cognitive transmitter. In some embodiments, the cognitive radio 100 may include a transceiver, instead of receiver 194 and transmitter 195, wherein the transceiver may operate as both a transmitter and a receiver.

Cognitive radio 100 may operate in a networking environment using connections to one or more computers, such as a remote computer connected to network interface 196. The remote computer may be a personal computer (PC), a server, a router, a network PC, a peer device or other common network node, and can include some or all of the elements described above relative to cognitive radio 100. Example networking environments that are commonplace in offices include enterprise-wide area networks (WAN), local area networks (LAN), intranets and the world wide networks such as the Internet.

For example, cognitive radio 100 may be the source from which data is being migrated, and the remote computer may be the destination to which the data is being migrated, or vice versa. Note however, that the source and destination need not be connected by a network 108 or any other means, but instead data may be migrated via any media capable of being written by the source and read by the destination. When used in a LAN or WAN networking environment, cognitive radio 100 may be connected to the LAN through a network interface 196 or an adapter. When used in a WAN networking environment, cognitive radio 100 typically may include a modem or other means for establishing communications over the WAN, such as the Internet or network 108. It will be appreciated that other means of establishing a communications link between the source and destination may be used. Cognitive radio 100 may also be connected to user output devices 197 for outputting information to a user. User output devices 197 may include one or more of a display, a printer and/or speakers.

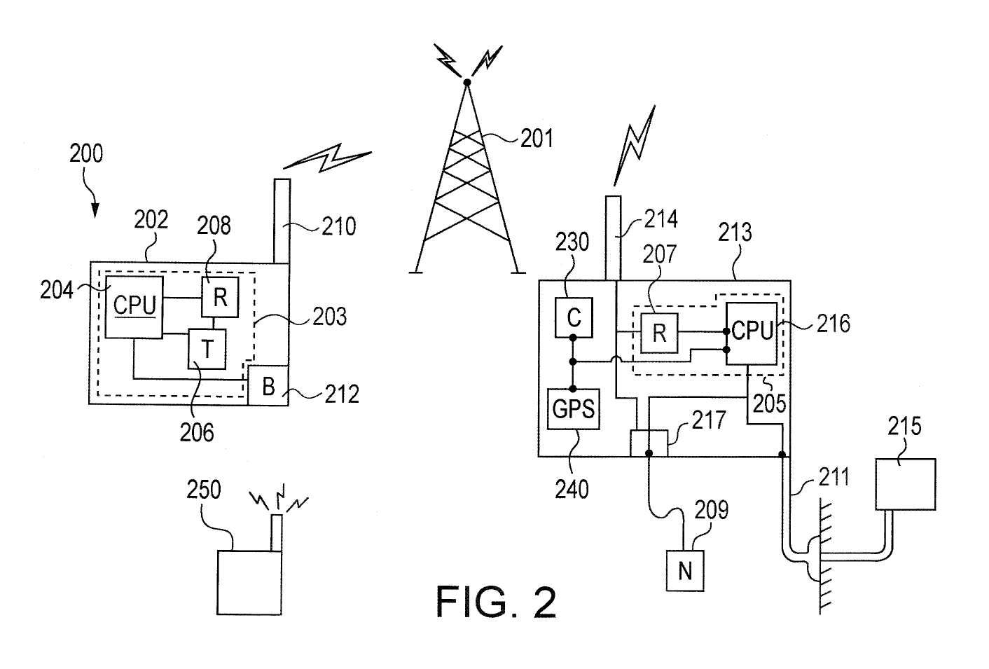

FIG. 2 depicts a schematic representation of a communications system arranged in accordance with at least some embodiments of the present disclosure. As shown in FIG. 2, a communications system 200 may be provided. The communications system 200 may include a communications device 202 that may be in communication with one or more of a cognitive device 213, a transmission tower 201, and/or another communications device 250.

The communications device 202 may be a device that may transmit or receive RF signals, and may be, for example, a wireless telephone, a radio, a hand-held two-way radio transceiver, or the like. The communications device 202 may include a cognitive radio 203, an antenna 210, and a power source 212. The cognitive radio 203 may be a wireless communication device that may be adapted to change its transmission or reception parameters to communicate efficiently and avoid interference with licensed or unlicensed users of other communications devices (e.g., communications device 250). The cognitive radio 203 may perform cognitive tasks, which may include the alteration of parameters based on the active monitoring of several factors in the external and/or internal radio environment, such as, for example, radio frequency spectrum, user behavior and/or network state. The cognitive tasks performed by cognitive radio 203 may begin with the passive sensing of RF stimuli, called spectrum sensing. The following are examples of other optional cognitive tasks that may be performed by cognitive radio 203: (1) radio-scene analysis, which may encompass: (1)(a) estimating interference temperature (a metric which quantifies sources of interference in a radio environment); and (1)(b) detecting spectrum holes, by spectrum sensing; (2) channel identification, which may encompass: (2)(a) estimation of channel-state information; and (2)(b) prediction of channel capacity for use by the transmitter; and (3) transmit-power control and/or dynamic spectrum management.

Cognitive radio 203 functionally may include all or some of the components of cognitive radio 100, as described above for FIG. 1. Cognitive radio 203 may also include at least a processor 204 arranged in communication with a receiver 208 and optionally a transmitter 206. In some examples, transmitter 206 and receiver 208 may be replaced with a transceiver. Processor 204 may be configured to send cognitive instructions to both the receiver 208 and transmitter 206 and may receive cognitive information, such as spectrum sensing information, from the receiver 208 when performing and processing cognitive tasks, such as spectrum sensing.

In some examples, a cognitive task of spectrum sensing may detect spectrum holes, which may be bands of unused radio frequencies in the radio frequency (RF) spectrum available for use by cognitive radio 203. The cognitive radio 203 and/or cognitive receiver 205 may passively sense the RF spectrum and estimate the power spectra of incoming radio frequency stimuli, in order to classify the RF spectrum into one of three broadly defined types of radio frequencies. Although this disclosure is not limited to only three defined types of radio frequencies, example defined types of radio frequencies may include: (1) black spaces, which are occupied by high-power “local” interferers some of the time; (2) grey spaces, which are partially occupied by low-power interferers; and/or (3) white spaces, which are free of RF interferers except for ambient noise, made up of natural and artificial forms of noise. Examples of ambient noise may include: broadband thermal noise produced by external physical phenomena such as solar radiation; transient reflections from lightening, plasma (fluorescent) lights, and aircraft; impulsive noise produced by ignitions, commutators, and microwave appliances; and thermal noise due to internal spontaneous fluctuations of electrons at the front end of individual receivers.

White spaces and grey spaces, to a lesser extent, contain spectrum holes which make good candidates for use by cognitive radio 203. While black spaces are to be avoided when and where the RF emitters residing in them are switched ON, when those emitters are switched OFF, the black spaces assume a new role of “spectrum holes”. The cognitive radio 203 and/or cognitive receiver 205 provide the opportunity for discovering significant “white spaces” within the unused black spaces by invoking a dynamic-coordination capability for spectrum sharing.

In some examples, by conducting the cognitive task of spectrum sensing, cognitive radio 203 may be able to determine which portion of the RF spectrum contains frequencies that are not being utilized, identifying spectrum holes. Thereafter, receiver 208 within cognitive radio 203 and/or cognitive receiver 205 may communicate spectrum-sensing information that contains information regarding spectrum holes, to processor 204 within cognitive radio 203. The spectrum sensing information may typically contain bands of frequencies within the white spaces and the grey spaces, however sometimes the bands of frequencies may be within the black spaces. Examples of cognitive radios are described in: Haykin, S. “Cognitive Radio: Brain-Empowered Wireless Communications,” IEEE JOURNAL ON SELECTED AREAS IN COMMUNICATIONS, Vol. 23, No. 2, pp. 201-220 (February 2005).

Upon conducting the cognitive task of spectrum sensing and also determining which portion of the RF spectrum contains frequencies which may not be utilized (or available), receiver 208 within cognitive radio 203 may communicate spectrum sensing information to processor 204 within cognitive radio 203. The spectrum sensing information may contain information about spectrum holes. The spectrum sensing information may also contain bands of frequencies that may be within the white spaces and the grey spaces, or the bands of frequencies that may be within the black spaces.

In some embodiments, when performing a cognitive task of spectrum sensing, the processor 204 may be arranged to send cognitive instructions to the receiver 208 such that the receiver 208 is instructed to scan the RF spectrum for spectrum holes. The receiver 208 may be configured to send spectrum sensing information to the processor 204 to inform the processor 204 of spectrum holes (i.e., receiver 208 may inform the processor 204 which bands of RF frequencies may be available for use). The processor 204 may be configured to send cognitive instructions to the transmitter 206 which may be adapted to transmit at a radio frequency available for use, or within one of the spectrum holes.

Receiver 208 may be arranged to receive RF signals, either digital or analog, from antenna 210 and transmitter 206 may be configured to transmit RF signals through antenna 210. Antenna 210 may be arranged to transmit or receive RF signals to/from transmission tower 201. Tower 201 may be arranged to broadcast these RF signals, for example, via land lines or other RF signals, to other communications devices. These devices may include wireless communications devices, such as communications device 250, or wired communications devices such as telephones. Antenna 210 may be used to send RF signals to and receive signals from other communications devices 250 and cognitive device 213.

Power source 212 may be in arranged in communication with and may power cognitive radio 203. Power source 212 may be a portable device such as, for example, a battery, a fuel cell, a lithium ion battery, or a capacitor.

Cognitive tasks, such as spectrum sensing, may require the detection of spectrum holes and their subsequent exploitation in the management of radio spectrum, which may be time consuming and may use significant power. By offloading some cognitive tasks from cognitive radio 203 to another device, such as cognitive device 213, the amount of electrical and computational power used by communications device 202 may be reduced. The amount of time required to perform cognitive tasks within the communications device 202 may also be reduced.

Cognitive device 213 may include a cognitive receiver 205 that is arranged to process cognitive tasks, an antenna 214 configured to receive radio frequency signals, and a communications port 217. Cognitive device 213 may be arranged in communication with communications device 202 through a variety of means, such as, wired or wireless communications. Example wired communications may include USB, Firewire, and network cabling such as CAT-5 or fiber optic cable. Example wireless communications may include Bluetooth, Wi-Fi, WiMax, EDGE (Enhanced Data rates for GSM Evolution), GSM (Global System for Mobile communications), GPRS (General packet radio service), 3G, 4G, CDMA (Code division multiple access), or any other communications protocol which may transmit RF signals. In a LAN or WAN networking environment, cognitive device 213 may be adapted to communicate with communications device 202 through a network interface 196 (FIG. 1) or an adapter. In a WAN networking environment, cognitive device 213 may adapted to communicate through a modem or other means for establishing communications over the WAN, such as the Internet or network 108 (FIG. 1). Other means of establishing a communications link between the cognitive device 213 and the communications device 202 may also be used.

The cognitive receiver 205 may be implemented as a wireless communication device that may be adapted to change its reception parameters to communicate efficiently and avoid interference with licensed or unlicensed users of other communications devices (e.g., communications device 250). The cognitive receiver 205 may be arranged to perform cognitive tasks, which may include the alteration of parameters based on the active monitoring of several factors in the external and internal radio environment, such as radio frequency spectrum, user behavior and network state. Example cognitive tasks performed by cognitive receiver 205 may begin with the passive sensing of RF stimuli, called spectrum sensing, and an action may follow. The following examples of cognitive tasks may be performed by cognitive receiver 205: (1) radio-scene analysis, which may encompass: (1)(a) estimating interference temperature (a metric which quantifies sources of interference in a radio environment); and (1)(b) detecting spectrum holes, by spectrum sensing; (2) channel identification, which may encompass: (2)(a) estimation of channel-state information; and (2)(b) prediction of channel capacity for use by the transmitter.

Cognitive receiver 205 may include all the components of cognitive radio 100, as described above for FIG. 1. Cognitive receiver 205 may also include at least a processor 216 that may be arranged in communication with a receiver 207. Processor 216 may be arranged to send cognitive instructions to the receiver 207 and may be adapted to receive cognitive information from the receiver 207 when performing and processing cognitive tasks, such as a spectrum sensing task.

In some examples, when performing a cognitive task of spectrum sensing, the processor 216 may be configured to send cognitive instructions to the receiver 207 such that the receiver 207 is instructed to scan the RF spectrum for spectrum holes. The receiver 207 may be arranged to send spectrum sensing information to the processor 216 to inform the processor 216 of spectrum holes (i.e., receiver 207 may inform the processor 216 which bands of RF frequencies may be available for use). The process of sending spectrum sensing information to the processor 216 to inform the processor 216 of spectrum holes may be repeated multiple times for different parts of the RF spectrum. The processor 216 may be configured to send the cognitive information through the communications port 217 to the communications device 202, which may be adapted to receive the cognitive information through antenna 210 and forward the cognitive information to processor 204. Processor 204 may be arranged to instruct the transmitter 206 to transmit at a radio frequency that may be available for use, or within one of the spectrum holes. In this manner, cognitive receiver 205 may be configured to perform certain cognitive tasks that would otherwise be performed by cognitive radio 203. In doing so, cognitive receiver 205 may be able to reduce the amount of electrical and/or processing power used by cognitive radio 203. This may allow communications device 202 to be able to operate with a less powerful processor 204, a lower capacity power source 212, and/or to possibly operate for longer durations.

Communications port 217 may be arranged in communication with the communications device 202 and may communicate cognitive information to communications device 202. Communications port 217 may be in communication with the communications device 202 through a network 209. Communications port 217 may also be able to directly communicate with communications device 202 through antenna 214, and may be arranged to communicate cognitive information directly to communications device 202. Network 209 may be arranged in communication with both communications device 202 and cognitive device 213, for example, via a wired or wireless connection.

Receiver 207 may be configured to receive RF signals, either digital or analog, from antenna 214. Antenna 214 may be adapted to transmit or receive RF signals to/from transmission tower 201. Tower 201 may broadcast these RF signals, for example, via land lines or other RF signals, to other communications devices. These devices may include wireless communications devices, such as communications devices 202 and 250, or wired communications devices such as telephones. Antenna 214 can also be used to send and receive RF signals to and from communications device 202 and 250.

Cognitive device 213 may include a power source 211 that may be configured in communication with and power cognitive receiver 205. Power source 211 may include a power connector that may be configured to connect with a stationary power source 215, such as a power generating plant. In this manner, cognitive device 213 may be able to use a nearly limitless supply of power in order to process cognitive tasks which may otherwise be processed by communications device 202.

In some embodiments, cognitive device 213 may include a time determining device 230, as shown in FIG. 2. Time determining device 230 may be a device that is configured to determine the current time. Time determining device 230 can be a device which may be separate and apart from processor 216, or time determining device 230 can be incorporated within processor 216. Alternatively, time determining device 230 may be absent, and the time may be determined by instructions that are run by processor 216, or information received by processor 216, such as a network time protocol received by processor 216 or information gathered from other devices or computer in communication with processor 216.

In some examples, time determining device 230 may be arranged to determine the current time for the location at which cognitive device 213 resides. For example, if cognitive device 213 resides in Chicago, Ill., then the time determining device 230 may be arranged to determine the current time in the Central Time Zone for the United States. In some examples, time determining device 230 may be configured to determine the current time by searching for information regarding the current time on network 209; or by accessing other devices such as communications devices 202 or by accessing a remote time keeping device, such as a remote atomic clock like the NIST-FI at NIST laboratories in Boulder, Colo.; or by generating the current time based at least in part on a time generating device such as a clock. Once the current time is determined by time determining device 230, time information containing the current time may be generated by time determining device 230 and sent to the processor 216. Time information may contain the current time of day, the day of the week, the month, the year, the date including the day, month and year, and the time and date including the time of day, the day, month and year.

In some examples, based at least in part on time information which may be received by time determining device 230, the cognitive device 213 may be able to determine, using processor 216, whether or not to perform a cognitive task, or determine whether to perform a cognitive task in a certain way. Time information may be used to instruct cognitive device 213, and specifically processor 216, on how to perform a cognitive task at a set time of day. Depending on the current time, time information may also be used to prevent the processor 216 from generating and sending cognitive instructions to receiver 207, or information which instructs the processor 216 to generate and send a specific cognitive instruction to receiver 207. Time information may be preprogrammed into the cognitive device 213, may be obtained by the cognitive device over network 209, or may be determined by cognitive device by regularly performing cognitive tasks (e.g., spectrum sensing) throughout the day and then cataloging the results.

For example, time information may be used to determine, for particular points or periods of time during the day, which portions of the RF spectrum are typically being used or how much of the RF spectrum is being used. In this manner, cognitive device 213 can be configured to determine, based at least in part on time information, whether or not to scan the entire RF spectrum, or which portions of the RF spectrum are likely to include spectrum holes and to scan those specific portions only. For example, if the time information determines that the cognitive device 213 is operating at the current time of 9:00 am, and information received from network 209 indicates that people use the RF spectrum more between the hours of 8:00 am and 10:00 am than between the hours of 10:00 am and 12:00 pm, then the cognitive device 213 may be configured to be more selective in scanning the RF spectrum and scan selected portions of the RF spectrum.

In some embodiments, cognitive device 213 may include a location determining device 240, as shown in FIG. 2. Location determining device 240 may be a device that is configured to determine the current location of cognitive device 213. Location determining device 240 can be a device which may be separate and apart from processor 216, or location determining device 240 can be incorporated within processor 216. Alternatively, location determining device 240 may be absent, and the location may be determined by instructions which are run by processor 216. In some examples, the location may be determined by cognitive device 213, which may be configured to: search for information regarding the current location on network 209, access information from other devices such as communications devices 202, 250 or antenna 201, access information from a remote location generating device such as a remote Global Position System (GPS) device, or generate the current location internally using a location generating device such as an internal GPS device. Once the current location is determined, location information containing the current location may be generated and sent to the processor 216. In some examples, location information may include one or more of longitude and latitude coordinates of the cognitive device 213 within a set distance, and/or the name of the city, town, school, area, street, zip code, state, or country which cognitive device 213 resides in.

Based at least in part on location information, the cognitive device 213 may be configured to determine, using processor 216, whether or not to perform a cognitive task, or configured to determine whether to perform a cognitive task in a certain way. Location information may be used to instruct cognitive device 213, and specifically processor 216, on how to perform a cognitive task within a set location. Depending on the specific location in which the cognitive device 213 resides, location information may also be used to prevent the processor 216 from generating and sending cognitive instructions to receiver 207, or information which instructs the processor 216 to generate and send a specific cognitive instruction to receiver 207. Location information may be preprogrammed into the cognitive device 213, may be obtained by the cognitive device over network 209, or may be determined by cognitive device 213 by regularly performing cognitive tasks, (e.g., spectrum sensing), at different locations and then cataloging the results.

For example, location information may be used to determine, for particular locations, which portions of the RF spectrum are typically being used or how much of the RF spectrum is being used. In this manner, cognitive device 213 can be arranged to determine, based at least in part on location information, whether or not to scan the entire RF spectrum, or which portions of the RF spectrum are likely to include spectrum holes and to scan those specific portions only. For example, if the location information indicates that the cognitive device 213 is located in a college campus, and the cognitive location information indicates that people in college campuses in general, or that people within that particular college campus, use certain portion of the RF spectrum more than other portions, then the cognitive device 213 may decide, since it is located in a college campus, to be more selective in scanning the RF spectrum and scan only selected portions of the RF spectrum.

In some embodiments, cognitive device 213 may include time determining device 230 and location determining device 240, as shown in FIG. 2. In this embodiment, both location information and time information may be combined or used together, so that cognitive device 213 may determine whether or not to perform a cognitive task, or whether to perform a cognitive task in a certain way, at a set location and at a set time. For example, if the time information determines that the cognitive device 213 is operating at 9:00 am and the location information indicates that the cognitive device 213 is on a college campus, and information available from network 209 indicates that people in college campuses in general, or that people within that particular college campus, use more of the RF spectrum between the hours of 9:00 am and 5:00 pm than between 5:00 pm and 9:00 am, then the cognitive device 213 may decide to be more selective in scanning the RF spectrum than if the cognitive device 213 were located in a different place and/or scanning at different times.

FIGS. 3-5 are flowchart illustrations of methods, which can be carried out by an apparatus or systems, for example under instructions from a computer program product, according to at least some embodiments of the present disclosure. It will be understood that each block of the flowchart illustrations in FIGS. 3-5, and combinations of blocks in the flowchart illustrations in FIGS. 3-5, can be implemented by computer program instructions. These computer program instructions may be loaded onto a computer or other programmable data processing apparatus to produce a machine, such that the instructions which execute on the computer or other programmable data processing apparatus are means for implementing the functions specified in the flowchart block or blocks. These computer program instructions may also be stored in a storage device that can direct a computer or other programmable data processing apparatus to function in a particular manner, such that the instructions stored in the storage device are an article of manufacture including instruction which implement the function specified in the flowchart block or blocks. The computer program instructions may also be loaded onto a computer or other programmable data processing apparatus to cause a series of operational steps to be performed on the computer or other programmable data processing apparatus to produce a computer implemented process such that the instructions which execute on the computer or other programmable apparatus implement the functions specified in the flowchart block or blocks.

Accordingly, blocks of the flowchart illustrations in FIGS. 3-5 support combinations of means for performing the specified functions, combinations of steps for performing the specified functions and program instruction means for performing the specified functions. It will also be understood that each block of the flowchart illustrations in FIGS. 3-5, and combinations of blocks in the flowchart illustrations in FIGS. 3-5, can be implemented by special purpose hardware-based computer systems, such as a cognitive radio, which perform the specified functions or steps, or combinations of special purpose hardware and computer instructions.

Such computer instructions may be fixed either on a tangible medium, such as a computer readable medium (for example, a diskette, CD-ROM, ROM, or fixed disk) or transmittable to a computer system, via a modem or other interface device, such as a communications adapter connected to a network over a medium. The medium may be either a tangible medium (for example, optical or analog communications lines) or a medium implemented with wireless techniques (for example, microwave, infrared or other transmission techniques). The series of computer instructions embodies all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (for example, shrink wrapped software), preloaded with a computer system (for example, on system ROM or fixed disk), or distributed from a server or electronic bulletin board over the network (for example, the Internet or World Wide Web).

FIG. 3 depicts a flowchart illustration of methods, apparatus (systems) and computer program products, in accordance with at least some embodiments of the present disclosure. As seen in FIG. 3 the operation of cognitive device 213 (FIG. 2) in conjunction with communications device 202 (FIG. 2), is described. A method 300 for processing a cognitive task for a communications device including a cognitive radio, such as communications device 202, may be initiated in block 301. Upon initiating the method 300 for processing a cognitive task in block 301, processor 216 may be arranged to send cognitive instructions to the receiver 207 at block 302. The cognitive instructions may be any instruction that helps in accomplishing a cognitive task. In block 304, the receiver 207 may be adapted to receive the cognitive instructions and may begin to execute a cognitive task, such as spectrum sensing, which may result in the receiver 207 scanning the RF spectrum for spectrum holes.

After initiating the cognitive task, the receiver 207 then may be configured to send cognitive information back to the processor 216, at block 306. For example, the receiver 207 may be configured to send spectrum sensing information to the processor 216 informing the processor 216 of spectrum holes, that is, informing the processor 216 which bands of RF frequencies are available for use. The processor 216 may then be arranged to communicate the cognitive information to the communications device 202, at block 308. For example, the processor 216 may be arranged to communicate spectrum sensing information to the communications device 202. The cognitive information may be communicated directly to the communications device 202 through antenna 214, or indirectly through a network 209 coupled to communications port 217.

At block 310, communications device 202 may be configured to receive the cognitive information from cognitive device 213. Then at block 312 the communications device 202 may be configured to send the cognitive information to processor 204. Processor 204 may then be configured to send cognitive instructions to the transmitter 206 at block 314. The transmitter 206 may then be configured to execute the cognitive instructions at block 316. The cognitive instructions may be any instruction that helps in accomplishing a cognitive task. For example, the cognitive instructions sent by processor 204 to transmitter 206 may be adapted to instruct the transmitter 206 to transmit at a radio frequency that is available for use, or within one of the spectrum holes.

FIG. 4 depicts a flowchart illustration of methods, apparatus (systems) and computer program products, in accordance with embodiments of the present disclosure. As seen in FIG. 4 a method 400 for determining the current time and based at least in part on the current time, determining whether or not to perform a cognitive task, or determining whether to perform a cognitive task in a certain way, may be initiated in block 401. Upon initiating the method 400 in block 401, the cognitive device 213 may be arranged to determine the current time in block 402. The current time may be determined by including time determining device 230 within cognitive device 213 and then using time determining device 230 to generate time information or by sending time determining instructions to processor 216 and using processor 216 to determine the current time and generate or receive time information. If time determining instructions are sent to processor 216, processor 216 may in turn search for information regarding the current time on network 209, access other devices such as communications devices 202 or 250 and search for information regarding the current time, and to access a remote time keeping device, such as a remote clock, and search for information regarding the current time. Upon finding information regarding the current time, processor 216 may then request for time information to be transmitted to processor 216.

Once the current time is determined by cognitive device 213, time information containing the current time may be generated and sent to the processor 216 in block 404. Based at least in part on time information, the processor 216 may be able to determine whether or not to perform a cognitive task in block 406. If processor 216 determines that a cognitive task should be performed, then method 400 may proceed to block 407. If processor 216 determines that a cognitive task should not be performed, then method 400 may proceed to block 410, and the cognitive device 213 may not perform the cognitive task. Based at least in part on time information, either alone or in combination with cognitive location information, the processor 216 may be able to determine whether or not to perform the cognitive task in a set way, in block 407. If processor 216 determines that a cognitive task should be performed in a set way, then method 400 may proceed to block 412, and the cognitive device 213 performs the cognitive task in a set way. If processor 216 determines that the cognitive task should not be performed in a set way, then method 400 may proceed to block 408, and the cognitive device 213 may perform the cognitive task.

In some embodiments, the cognitive task may be spectrum sensing, and based at least in part on the time information received, the processor 216 may decide whether or not to perform spectrum sensing, or may determine whether to perform spectrum sensing a set way. In this embodiment, depending on the current time, the processor 216 may either determine on its own, or be programmed with, information which includes information on whether or not to perform spectrum sensing or information on whether to perform spectrum sensing in a set way. For example, information from network 209 may instruct the processor 216 as to which spectrum holes are present in the RF spectrum for a set time of day. Then, depending on the current time within the time information, the processor 216 may instruct the receiver 207 to search or not search the RF spectrum for spectrum holes.

Alternatively, depending on the current time within the time information, the processor 216 may instruct the receiver 207 to search the RF spectrum in a particular way. For example, it may be determined that in a first time period, such as between 2:00 pm and 4:00 pm on a given day of the week, the RF spectrum typically may be used heavily and that a small first spectrum hole exists at a first frequency range. Additionally, it may also be determined that in a second time period, such as between 5:00 pm and 11:00 pm on the same given day of the week, the RF spectrum typically may be used lightly and that a large second spectrum hole exists at a second frequency range. If the processor 216 determines, based at least in part on the time information, that the processor 216 is within the first time period, then the processor 216 may generate and send cognitive instructions to the receiver 207 to instruct the receiver 207 to scan the RF spectrum for spectrum holes within the first spectrum hole. In turn, the receiver 207 may send first spectrum sensing information to the processor 216 to inform the processor 216 of spectrum holes, that is, informing the processor 216 which bands of RF frequencies are available for use within the first spectrum hole. Additionally, if the processor 216 determines, based at least in part on the time information, that the processor 216 is within the second time period, then the processor 216 may generate and send cognitive instructions to the receiver 207 to instruct the receiver 207 to scan the RF spectrum for spectrum holes within the second spectrum hole. In turn, the receiver 207 may send second spectrum sensing information to the processor 216 to inform the processor 216 of spectrum holes, that is, informing the processor 216 which bands of RF frequencies are available for use within the second spectrum hole.

In this manner, by receiving time information, the processor 216 may be able to instruct receiver 207 to scan the RF spectrum in a particular way, that may be to scan for spectrum holes within a specific frequency range, such as the first or second frequency range, then the receiver 207 may scan the RF spectrum for spectrum holes in a shorter amount of time. This process of scanning the RF spectrum for spectrum holes within a specific frequency range may be repeated multiple times for different parts of the RF spectrum.

Upon performing the cognitive task or performing the cognitive task in a set way, cognitive information may be sent to the processor 216, at block 414. Upon receiving the cognitive information, the processor 216 may then send the cognitive information to the communications device 202, which may in turn receive the cognitive information and forward the cognitive information to processor 204, at block 416.

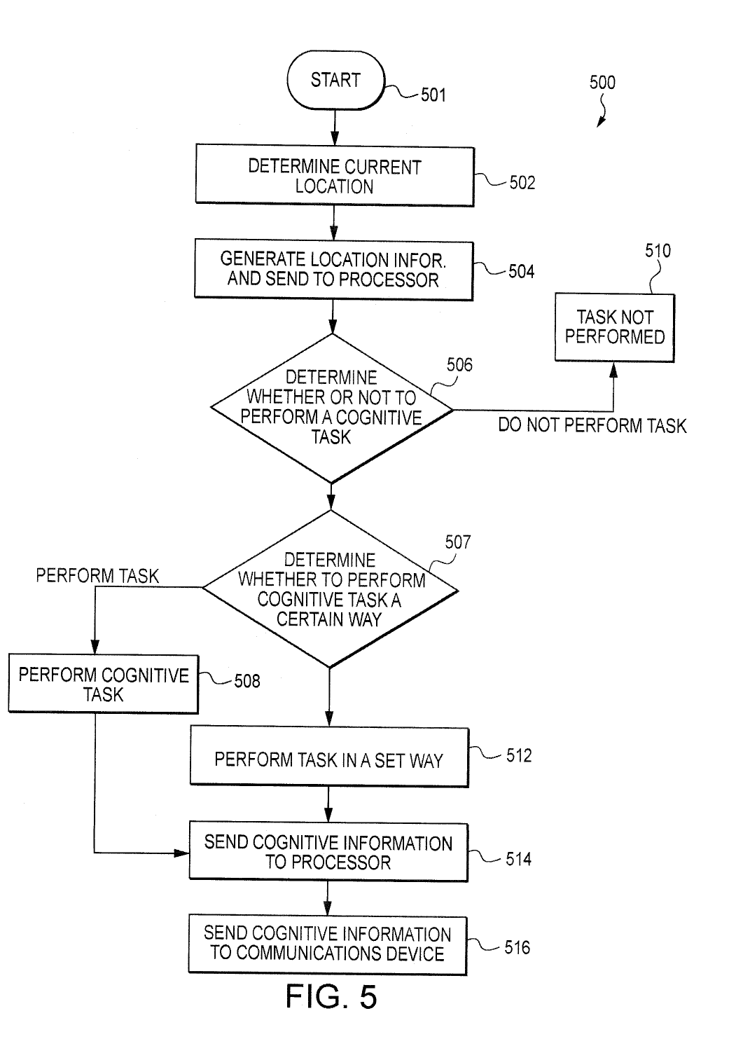

FIG. 5 depicts a flowchart illustration of methods, apparatus (systems) and computer program products, in accordance with embodiments of the present disclosure. As seen in FIG. 5, a method 500 for determining the current location and based at least in part on the current location, determining whether or not to perform a cognitive task, or whether to perform a cognitive task in a certain way, may be initiated in block 501.

Upon initiating the method 500 in block 501, the cognitive device 213 may be configured to determine the current location in block 502. The current location may be determined by including location determining device 240 within cognitive device 213 and then based at least in part on location determining device 240 to generate location information or by sending location determining instructions to processor 216 and using processor 216 to determine the current location and generate or receive location information. If location determining instructions are sent to processor 216, processor 216 may in turn search for information regarding the current location on network 209, access other devices such as communications devices 202 or 250 and search for information regarding the current location, or access a remote location generating device such as a remote Global Position System (GPS) device. Upon finding information regarding the current location, processor 216 may then request for location information to be transmitted to processor 216.

Once the current location is determined by cognitive device 213, location information containing the current location may be generated and sent to the processor 216 in block 504. Based at least in part on location information, either alone or in combination with cognitive location information, the processor 216 may be able to determine whether or not to perform a cognitive task in block 506. If processor 216 determines that a cognitive task should be performed, then method 500 may proceed to block 507. If processor 216 determines that a cognitive task should not be performed, then method 500 may proceed to block 510, and the cognitive device 213 may not perform the cognitive task. Based at least in part on location information, either alone or in combination with cognitive location information, the processor 216 may be able to determine whether or not to perform the cognitive task in a set way, in block 507. If processor 216 determines that a cognitive task should be performed in a set way, then method 500 may proceed to block 512, and the cognitive device 213 may perform the cognitive task in a set way. If processor 216 determines that the cognitive task should not be performed in a set way, then method 500 may proceed to block 508, and the cognitive device 213 may perform the cognitive task.

In some embodiments, the cognitive task may be a spectrum sensing task, and based at least in part on the location information received, the processor 216 may be arranged to decide whether or not to perform the spectrum sensing task, or whether to perform the spectrum sensing task but in a set way. The processor 216 may be configured to either determine on its own, or be programmed with, location information which may include information on whether or not to perform the spectrum sensing task or information on whether to perform the spectrum sensing task in a set way, depending on the current location. For example, cognitive location information may be adapted to instruct the processor 216 as to which spectrum holes are present in the RF spectrum for a set location. Then, depending on the current location within the location information, the processor 216 may be adapted to instruct the receiver 207 to search or not search the RF spectrum for spectrum holes.

Alternatively, depending on the current location within the location information, the processor 216 may be configured to instruct the receiver 207 to search the RF spectrum in a particular way. For example, it may be determined that in a first location, such as a college campus, the RF spectrum typically may be used heavily and that a small first spectrum hole exists at a first frequency range. Additionally, it may also be determined that in a second location, such as a user's home, the RF spectrum typically may be used lightly and that a large second spectrum hole exists at a second frequency range. If the processor 216 determines, based at least in part on the location information, that the processor 216 is within the first location, then the processor 216 may be arranged to generate and/or send cognitive instructions to the receiver 207 to instruct the receiver 207 to scan the RF spectrum for spectrum holes within the first spectrum hole. In turn, the receiver 207 may be arranged to send first spectrum sensing information to the processor 216 to inform the processor 216 of spectrum holes, that is, informing the processor 216 which bands of RF frequencies are available for use within the first spectrum hole. Additionally, if the processor 216 determines, based at least in part on the location information, that the processor 216 is within the second location, then the processor 216 may be arranged to generate and send cognitive instructions to the receiver 207 instructing the receiver 207 to scan the RF spectrum for spectrum holes within the second spectrum hole. In turn, the receiver 207 may be arranged to send second spectrum sensing information to the processor 216 to inform the processor 216 of spectrum holes, that is, informing the processor 216 which bands of RF frequencies are available for use within the second spectrum hole.

In this manner, by receiving location information, the processor 216 may be arranged to instruct receiver 207 to scan the RF spectrum in a particular way, that may be to scan for spectrum holes within a specific frequency range, such as the first or second frequency range, then the receiver 207 may scan the RF spectrum for spectrum holes in a shorter amount of time. This process of scanning the RF spectrum for spectrum holes within a specific frequency range may be repeated multiple times for different parts of the RF spectrum.

Upon performing the cognitive task or performing the cognitive task in a set way, cognitive information may be sent to the processor 216, at block 514. Upon receiving the cognitive information, the processor 216 may then send the cognitive information to the communications device 202, which may in turn receive the cognitive information and forward the cognitive information to processor 204, at block 516.

In some embodiments, methods 400 and 500 may be combined and both location information and time information may be obtained and combined so that cognitive device 213 may determine whether or not to perform a cognitive task, or determine whether to perform a cognitive task in a certain way, within a set location and at a set time.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various embodiments have been described, it will be apparent to those of ordinary skill in the art that other embodiments and implementations are possible within the scope of the claimed subject matter. Accordingly, the claimed subject matter is not to be restricted except in light of the attached claims and their equivalents.

1. A communications system, comprising:
a first cognitive device, comprising
a first processor,
a first receiver arranged in communication with the first processor to receive cognitive information from a second cognitive device, and
optionally, a first transmitter arranged in communication with the first processor to send cognitive information to the second cognitive device,
the first cognitive device is either configured to receive time information and/or location information from the second cognitive device via the first receiver, or the first cognitive device comprises an information determining device arranged in communication with the first processor and adapted to determine time information and/or location information, and
the first cognitive device is configured to select and execute a cognitive task via the processor in response to the time information and/or the location information.

2. The communications system of claim 1, wherein the time information and/or the location information comprises the time information.

3. The communications system of claim 2, wherein the first cognitive device comprises the information determining device, and the information determining device is a clock.

4. The communications system of claim 1, wherein the time information and/or the location information comprises the location information.

5. The communications system of claim 4, wherein the first cognitive device comprises the information determining device, and the information determining device is a Global Positioning System device.

6. The communications system of claim 1, further comprising a stationary power source adapted to power the first cognitive device.

7. The communications system of claim 1, wherein the first cognitive device is adapted to communicate with the second cognitive device through a network.

8. The communications system of claim 1, wherein the cognitive task is spectrum sensing.

9. A method for a first cognitive device to perform a cognitive task, the method for the first cognitive device comprising:
receiving cognitive information from a second cognitive device, or sending cognitive information to the second cognitive device;
receiving time information and/or location information from the second cognitive device; or determining time information and/or location information with an information determining device, wherein the first cognitive device includes the information determining device; and
selecting and executing a cognitive task based on the time information and/or location information.

10. The method of claim 9, wherein the cognitive task is spectrum sensing.

11. The method of claim 9, wherein the cognitive information is spectrum sensing information.

12. The method of claim 9, comprising receiving time information and/or location information from the second cognitive device.

13. The method of claim 9, wherein the cognitive device is a cognitive radio.

14. The method of claim 9, wherein the time information and/or the location information comprises the time information.

15. The method of claim 9, wherein the time information and/or the location information comprises the location information.

16. A computer program product comprising software encoded in computer-readable media, to perform a cognitive task with a first cognitive device, the software comprising instructions, operable when executed by the first cognitive device, to:
receive cognitive information from a second cognitive device, or send cognitive information to the second cognitive device;
receive time information and/or location information from the second cognitive device; or determine time information and/or location information with an information determining device, wherein the first cognitive device includes the information determining device; and
select and execute a cognitive task based on the time information and/or location information.

17. The computer program product of claim 16, wherein the cognitive information is spectrum sensing information.

18. The computer program product of claim 16, wherein the cognitive device is a cognitive radio.

19. The computer program product of claim 16, wherein the time information and/or the location information comprises the time information.

20. The computer program product of claim 16, wherein the time information and/or the location information comprises the location information.
